(19) United States
(12) Patent Application Publication
(10) Pub. No.: US 2012/0011266 A1
(43) Pub. Date: Jan. 12, 2012

(54) METHOD AND APPARATUS FOR PROVIDING A REAL TIME STREAMING PROTOCOL SESSION

(75) Inventor: Ranjit Avasarala, Bangalore (IN)

(73) Assignee: GENERAL INSTRUMENT CORPORATION, Horsham, PA (US)

(21) Appl. No.: 13/168,422

(22) Filed: Jun. 24, 2011

Related U.S. Application Data
(60) Provisional application No. 61/361,757, filed on Jul. 6, 2010.

(51) Int. Cl. G06F 15/16

(52) U.S. Cl. 709/231

(57) ABSTRACT

The present disclosure describes a methods and apparatuses for providing a Real Time Streaming Protocol (RTSP) media streaming session to a target device. In particular, the present disclosure describes methods and apparatuses for using a client to transfer or share a particular media streaming session to a target device. The present disclosure also describes a client initiated request to modify a RTSP streaming media session and a server initiated setup message for modifying a RTSP session.

This application claims the benefit of U.S. Provisional Application No. 61/361,757 filed on Jul. 6, 2010, titled “Mechanism for Session Sharing and Transfer in RTSP Based Streaming Systems”, herein incorporated by reference in its entirety.

### BACKGROUND

The Real Time Streaming Protocol, or RTSP, is an application-level protocol for control over the delivery of data with real-time properties. RTSP provides an extensible framework to enable controlled, on-demand delivery of real-time data, such as audio and video. Sources of data can include both live data feeds and stored clips. This protocol is intended to control multiple data delivery sessions, provide a means for choosing delivery channels such as User Datagram Protocol (UDP), multicast UDP and Transmission Control Protocol (TCP), and provide a means for choosing delivery mechanisms based upon Real-time Transport Protocol (RTP).

Currently in Real Time Streaming Protocol (RTSP) based systems, clients can initiate and teardown streaming sessions. For example, Video on Demand (VoD) sessions are setup and torn down using mainly RTSP protocol. The RTSP protocol facilitates session setup, session teardown, playing, pausing and recording of session streaming content. However, there is currently no way of using RTSP to transfer and share sessions across devices. More specifically, the current RTSP protocol has no mechanism for sharing of streaming sessions with other devices nor for transferring of a streaming sessions from one device to another device. Therefore there is a need in the art for a solution addressing the above-mentioned shortcomings.

### SUMMARY

A method and apparatus for providing a Real Time Streaming Protocol (RTSP) media streaming session to a target device is disclosed. In one embodiment, an instruction to provide the RTSP media streaming session to the target device is received. A request to modify the RTSP media streaming session is generated. The request is sent to a server.

In one embodiment, the request may be a MODIFY request. The MODIFY request comprises at least a Require header, a Session header, and a Target header. The Require header may be an option-tag that describes an action the client wants the server to perform. In one embodiment, the action to be performed may be transferring the RTSP media streaming session to the target. In another embodiment, the action to be performed comprises sharing the RTSP media streaming session with the target.

The Session header may list the session to which a request belongs. The Target header may include an address of the target device.

A client initiated request to modify a Real Time Streaming Protocol streaming media session is disclosed. In one embodiment, the client initiated request may include stream information and additional header information used to provide a streaming session to a target device. The additional header information may be at least a Require header, a Session header, and a Target header. The Require header may be an option-tag that describes an action the client wants the server to perform. In one embodiment, the action to be performed may be transferring the RTSP media streaming session to the target. In another embodiment, the action to be performed comprises sharing the RTSP media streaming session with the target.

A server initiated setup message for modifying a Real Time Streaming Protocol session is disclosed. The server initiated message may include transport parameters selected by the server for data transmission and additional header information used to provide a streaming session to a target device. The additional information may be a Referred By header.

A method and apparatus for providing a Real Time Streaming Protocol (RTSP) media streaming session to a target device is disclosed. In one embodiment, a request to modify the RTSP media streaming session from a client is received. The information in the request is checked for additional header information. The RTSP media streaming session is provided to the target device using the additional header information. The additional header information may be at least a Require header, a Session header, and a Target header.

In one embodiment, the RTSP media streaming session is transferred to the target device. A setup message may be sent to the target device in order to transfer the RTSP media streaming session to the target device.

In one embodiment, the RTSP media streaming session is shared with the target device. A setup message may be sent to the target device in order to share the RTSP media streaming session with the target device.

A method and apparatus for providing a Real Time Streaming Protocol (RTSP) media streaming session to a target device is disclosed. In one embodiment, a setup message is received from a server. The setup message may include, at least a Referred-By header. The target device then joins the RTSP media streaming session.

### BRIEF DESCRIPTION OF THE DRAWINGS

So that the manner in which the above recited features of the present invention are attained and can be understood in detail, a more particular description of the invention, briefly summarized above, may be had by reference to the embodiments thereof which are illustrated in the appended drawings.

It is to be noted, however, that the appended drawings illustrate only typical embodiments of this invention and are therefore not to be considered limiting of its scope, for the invention may admit to other equally effective embodiments.

FIG. 1 illustrates a system for providing a RTSP streaming session to a target device according to one embodiment;

FIG. 2 illustrates a client-based method for providing a RTSP streaming session to a target device according to one embodiment;

FIG. 3 illustrates a server-based method for providing a Real Time Streaming Protocol (RTSP) media streaming session to a target device according to one embodiment;

FIG. 4 illustrates a target device based method for providing a Real Time Streaming Protocol (RTSP) media streaming session to the target device according to one embodiment;

FIG. 5 illustrates exemplary MODIFY method requests according to one embodiment;

FIG. 6 illustrates an exemplary RTSP solution for session transfer according to one embodiment;

FIG. 7 illustrates an exemplary RTSP Solution for session transfer that includes the use of MODIFY to indicate session sharing according to one embodiment; and

FIG. 8 illustrates a system 800 for providing an RTSP streaming session to a target device according to one embodiment.

### DETAILED DESCRIPTION

The present disclosure illustrates methods and apparatuses for using a client to transfer or share a particular media streaming session to a target device.

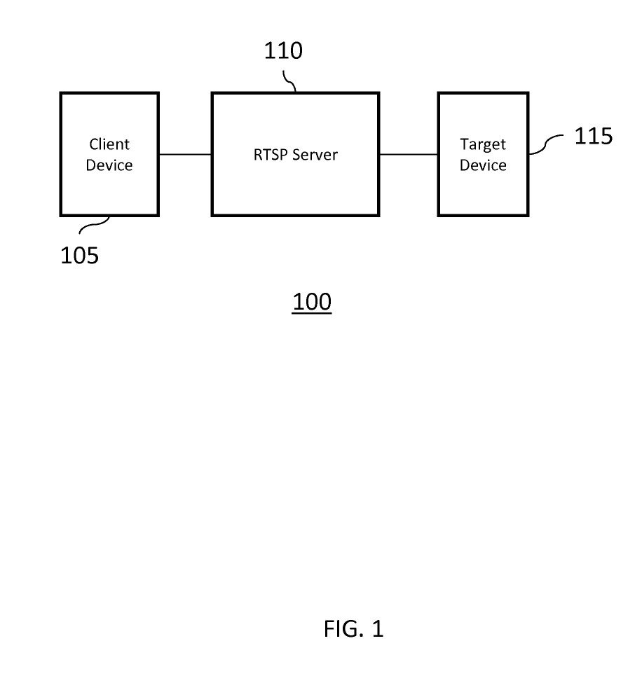

FIG. 1 illustrates a system 100 for allowing a client 105 to transfer or share a particular media streaming session to a target device 115 via an RTSP server 110. Client 105 may be a set top box (STB), personal digital assistant (PDA), digital video recorder (DVR), computer, or mobile device, e.g. a laptop, netbook, tablet, portable media device, or wireless phone. Likewise, target device 115 may also be a set top box (STB), personal digital assistant (PDA), digital video recorder (DVR), computer, or mobile device, e.g. a laptop, netbook, tablet, portable media device, or wireless phone. A new MODIFY request is introduced with a “Require” header to specify the action to be taken and a new header “Target” to specify the target device. This request has semantics similar to that of the SETUP request of Internet Engineering Task Force (IETF) Request for Comments (RFC) 2326 but includes at least the following additional headers: Require, Session, and Target.

When the require header has an option-tag value of “Require: transfer”, the client is requesting transferal of the session to a target device. When the require header has an option-tag value of “Require: share” the client is requesting sharing of the session with a target device. The target header comprises a device address or URL of the target device.

The present disclosure provides a mechanism for RTSP servers, e.g. RTSP server 110, to facilitate the transfer and sharing for streaming sessions among devices. In one embodiment, the server, upon receiving a MODIFY request from a client may send a SETUP request to the target device in order to effect transferal or sharing of the media session.

Embodiments of the present disclosure may be used in streaming devices like subscriber devices, e.g. Internet Protocol Set Top Boxes (IPSTBs) or streaming servers. For example, embodiments of the present disclosure may be a feature in Motorola IP-STBs that support only RTSP and HTTP based streaming.

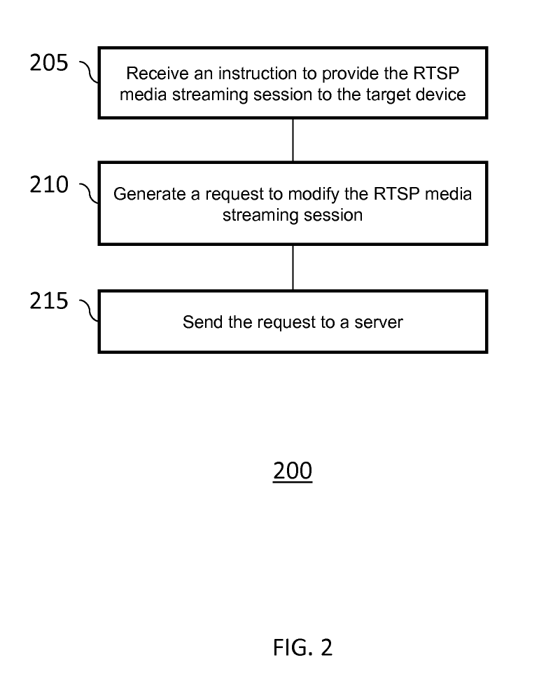

FIG. 2 illustrates a method 100 for providing a RTSP streaming session to a target device. At step 205, a client device, e.g. client 105, 605, 705 receives an instruction to provide the RTSP media streaming session to target device 115, 615, 715. This instruction may be triggered by a user via either a generic remote control command or a menu option of the client device to transfer a streaming session to or share a session with a target device. Once the client device receives the instruction to provide (share or transfer) the session, a MODIFY request is generated. Situations triggering the MODIFY request would be (a) to transfer an ongoing streaming session from one device to another; and (b) to share a particular streaming session with another device.

At step 210, client device 105, 605, 705 generates a request to modify the RTSP media streaming session. The MODIFY request includes a new header “Target” to specify the target device. The MODIFY request has semantics similar to that of the SETUP request of Internet Engineering Task Force (IETF) Request for Comments (RFC) 2326 but includes at least the following additional headers: Require, Session, and Target.

The Require header contains an option-tag that describes what action the client wants the server to perform. In one embodiment, a client will use a MODIFY request to share a session. In this embodiment, the Require header comprises “share” in the MODIFY request. In another embodiment, a client will use a MODIFY request to transfer a session. In this embodiment, the Require header comprises “transfer” in the MODIFY request.

The Session header lists the session to which a request belongs. The Target header includes the address of a new target device (if the value of option-tag in the Require header is either “share” or “transfer”). The option-tag describes an action that the client wants the server to perform, e.g. share or transfer.

At step 215, the request is sent to a server, e.g. server 110, 610, 710. The MODIFY request is sent by the client to a server, e.g. a media server or RTSP server, to provide a media streaming session to a target. The client sends a MODIFY request to the server when the client wants to trigger session transfer or sharing. The target destination, e.g. address or URL, is specified in the Target header.

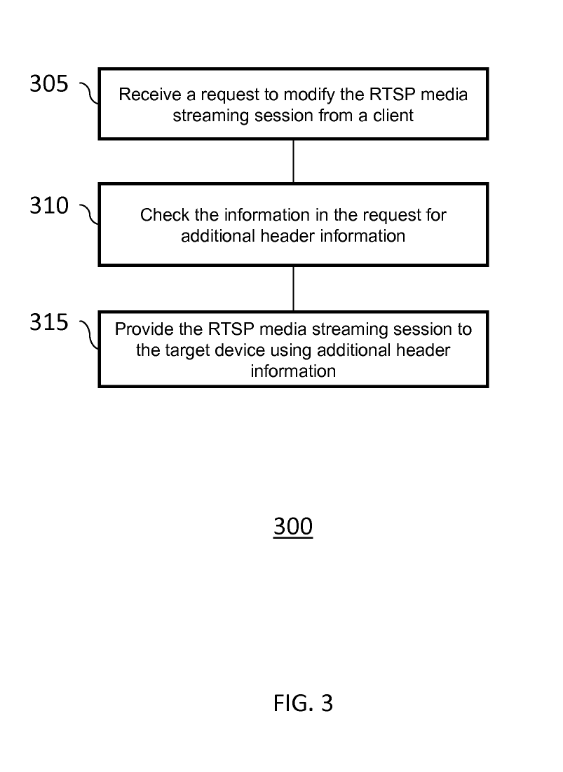

FIG. 3 illustrates a method for providing a Real Time Streaming Protocol (RTSP) media streaming session to a target device. At step 305 a request, e.g. a MODIFY request, to modify the RTSP media streaming session is received from a client. At step 310, the information in the request is checked for additional header information. The additional header information may comprise one or more headers, e.g. a require header, a session header, and a target header.

In one embodiment, a setup message is sent from the server to the target device. The SETUP request for a Uniform Resource Identifier (URI) specifies the transport mechanism to be used for the streamed media. A server can issue a SETUP request for a stream that is already playing to change transport parameters, or in the event of a MODIFY method initiated by a client. For the benefit of any intervening firewalls, a server must indicate the transport parameters, for example, where the server advertises a fixed multicast address. The Transport header specifies the transport parameters selected by the server for data transmission; the response will contain the transport parameters acceptable to the target.

In another embodiment, the server could send a short message (Session Initiation Protocol (SIP) MESSAGE) with the RTSP URL and the target could initiate RTSP session. If the target device is unreachable or prohibited, the server, e.g. an RTSP server, may send a “462” or “463” error response to the client. Otherwise, at step 315, the RTSP media streaming session is provided to the target device using the additional header information. If transfer or sharing of the media streaming session with the target device is successful, the server will send a “200” OK message to the client.

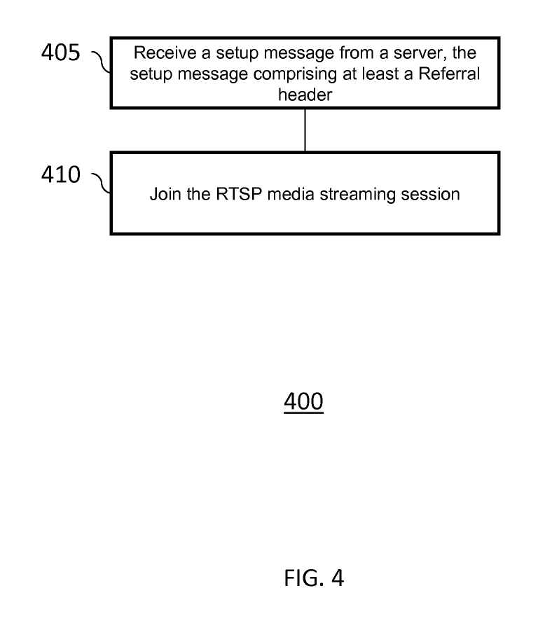

FIG. 4 illustrates a method for providing a Real Time Streaming Protocol (RTSP) media streaming session to a target device. At step 405, the target device receives a setup message from a server.

In one embodiment, the setup message may comprise at least a Referred By header. SETUP may include information related to the session—like session start time and duration. A new header “Referred-By” indicates the source of the session [e.g. the device that initiated the session and referred to server].

At step 410, the target device joins the RTSP media streaming session. When a client device wishes to transfer a particular streaming session with another device, the client first sends an indication to the streaming server by sending a MODIFY method with the required information. Then the server looks at the MODIFY method and then at the Require header and determines the action to be taken. If the value of Require header is “transfer”, then the server initiates a new session with the target device and once the session is established with the new device, disconnects the existing session with the previous device. If the value of Require header is “share”, then the server initiates new session with the target device. The target device receives a request for a new session—like incoming RTSP SETUP request to setup a streaming session or an incoming SIP MESSAGE method request with RTSP URI to start a session with server.

Those of skill in the art will appreciate that the present application discloses novel methods and apparatuses for RTSP session transfer/share. By the present disclosure, the ability of RTSP is expanded to provide session transfer and session sharing. Further, certain session attributes (for example paused session pause time or NPT) could be added. When the streaming session is paused, the streaming server records the paused time and puts that value in the outgoing SETUP request towards the target. The target can then choose to start the session from the mentioned time.

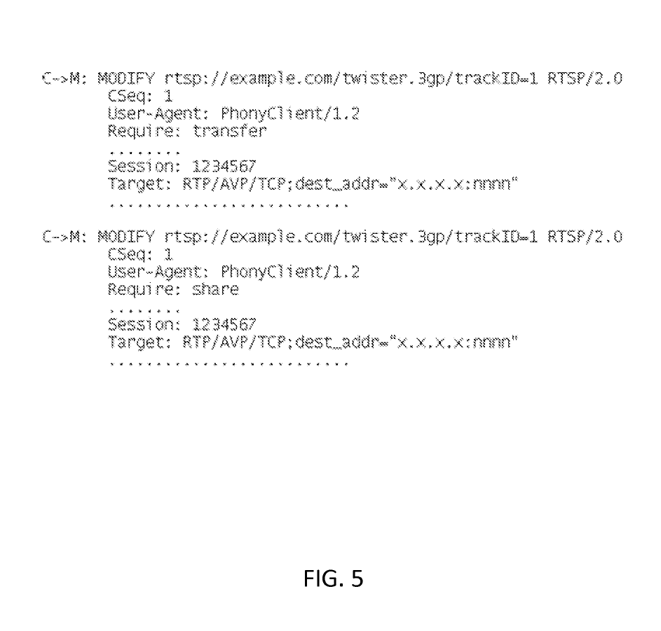

FIG. 5 illustrates exemplary MODIFY method requests. A new MODIFY request is introduced with a new header “Target” to specify the target device. This request has semantics similar to that of the SETUP request of IETF RFC 2326 but includes stream information and at least the following additional headers: Require, Session, and Target.

The Require header contains an option-tag that describes what action the client wants the server to perform. In one embodiment, a client will use a MODIFY request to share a session. In this embodiment, the Require header comprises “share” in the MODIFY request. In another embodiment, a client will use a MODIFY request to transfer a session. In this embodiment, the Require header comprises “transfer” in the MODIFY request.

The Session header lists the session to which a request belongs. The Target header includes the address of a new target device (if the value of option-tag in the Require header is either “share” or “transfer”).

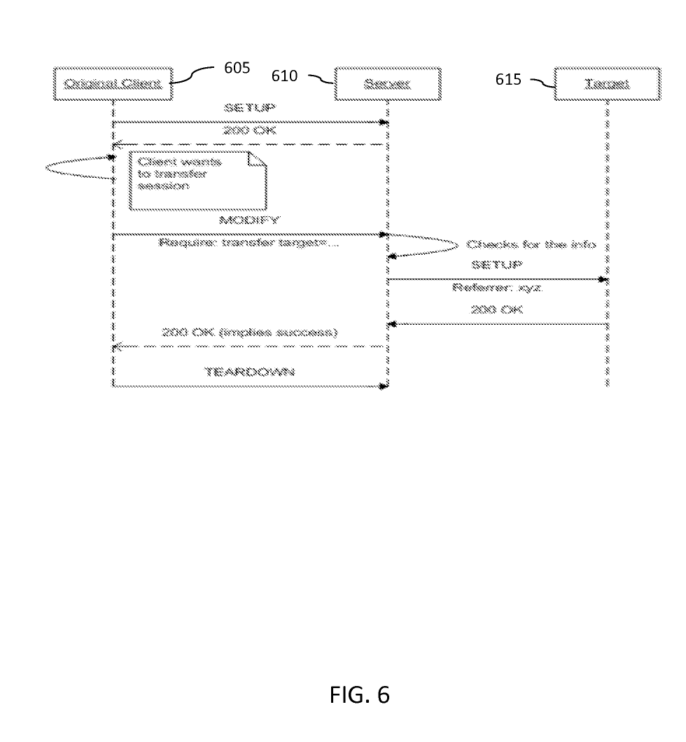

FIG. 6 illustrates an exemplary RTSP Solution—Session Transfer. Client 605 initiates a SETUP request towards server 610. Server 610 indicates that the SETUP request was successful by sending a message indicating “200 OK”. Client 605 determines that a session transfer is needed/wanted. Client 605 sends a MODIFY request having a Require header indicated as “transfer”. Server 610 checks for the information contained in the MODIFY request. The target address is specified in the Target header of the MODIFY request. Server 610 sends a SETUP request towards target 615 upon receiving the MODIFY request with Require: transfer. The SETUP request includes a Referred-By header that indicates client 605 as the device that initiated the transfer. The Referred By header may be part of the SETUP request to indicate the device that referred the session. Target 615 indicates that the SETUP request was successful by sending a message indicating “200 OK”. Original client 605, after receiving “200 OK” for the MODIFY request from server 610, sends a TEARDOWN request to end the session to server 610.

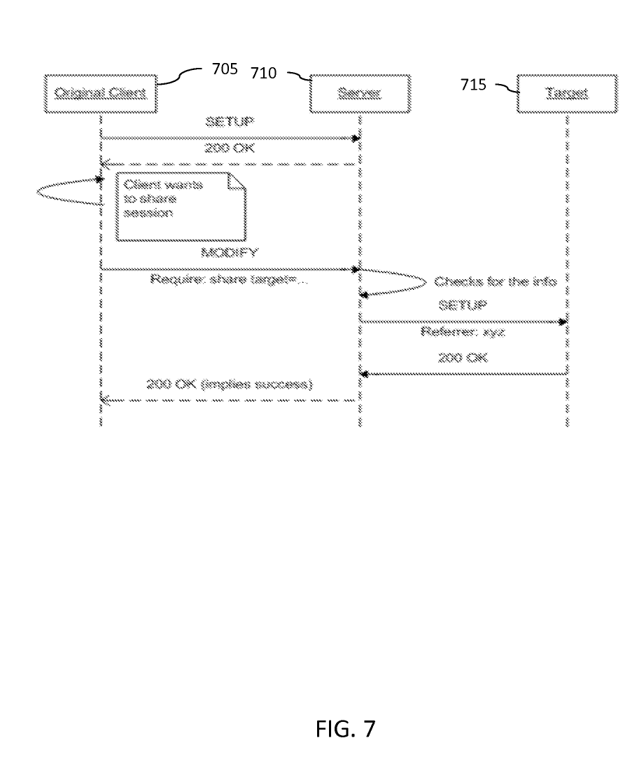

FIG. 7 illustrates an exemplary RTSP Solution—Session Transfer that includes the use of MODIFY to indicate “Session Sharing”. Client 705 initiates a SETUP request towards server 710. Server 710 indicates that the SETUP request was successful by sending a message indicating “200 OK”. Client 705 determines that a session transfer is needed/wanted. Client 705 sends a MODIFY request having a Require header indicated as “share”. Server 710 checks for the information contained in the MODIFY request. The target address is specified in the Target header of the MODIFY request. Server 710 sends a SETUP request towards target 715 upon receiving the MODIFY request with Require: share. The SETUP request includes a Referred By header that indicates client 705 as the device that initiated the transfer. Target 715 indicates that the SETUP request was successful by sending a message indicating “200 OK”. Original client 705, after receiving “200 OK” for the MODIFY request from server 710, continues to be in the session.

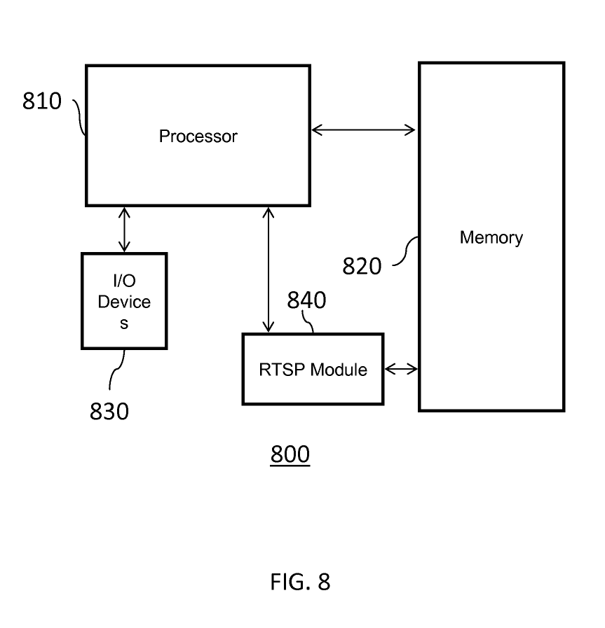

FIG. 8 illustrates a block diagram of an example device 800. Specifically, device 800 can be employed to perform RTSP methods, e.g. MODIFY and/or server-based SETUP using RTSP module 840. Device 800 may be implemented in RTSP server 110, 610, 710, client 105, 605, 705, or target 115, 615, 715.

Device 800 comprises a processor (CPU) 810, a memory 820, e.g., random access memory (RAM) and/or read only memory (ROM), RTSP module 840, and various input/output devices 830, (e.g., storage devices, including but not limited to, a tape drive, a floppy drive, a hard disk drive or a compact disk drive, a receiver, a transmitter, network attached storage, and other devices commonly required in multimedia, e.g. content delivery, system components).

It should be understood that RTSP module 840 can be implemented as one or more physical devices that are coupled to the CPU 810 through a communication channel. Alternatively, RTSP module 840 can be represented by one or more software applications (or even a combination of software and hardware, e.g., using application specific integrated circuits (ASIC)), where the software is loaded from a storage medium, (e.g., a magnetic or optical drive or diskette) and operated by the CPU in the memory 820 of the computer. As such, RTSP module 840 (including associated data structures) of the present invention can be stored on a computer readable medium, e.g., RAM memory, magnetic or optical drive or diskette and the like.

The processes described above, including but not limited to those presented in connection with FIGS. 2-5, may be implemented in general, multi-purpose or single purpose processors. Such a processor will execute instructions, either at the assembly, compiled or machine-level, to perform that process. Those instructions can be written by one of ordinary skill in the art following the description of presented above and stored or transmitted on a computer readable medium, e.g. a non-transitory computer-readable medium. The instructions may also be created using source code or any other known computer-aided design tool. A computer readable medium may be any medium capable of carrying those instructions and include a CD-ROM, DVD, magnetic or other optical disc, tape, silicon memory (e.g., removable, non-removable, volatile or non-volatile), packetized or non-packetized wireline or wireless transmission signals.

While the foregoing is directed to embodiments of the present invention, other and further embodiments of the invention may be devised without departing from the basic scope thereof, and the scope thereof is determined by the claims that follow.

What is claimed is:

1. A method for providing a Real Time Streaming Protocol (RTSP) media streaming session to a target device, comprising:
receiving an instruction to provide the RTSP media streaming session to the target device;
generating a request to modify the RTSP media streaming session; and
sending the request to a server.

2. The method of claim 1, wherein the request comprises a MODIFY request.

3. The method of claim 2, wherein the MODIFY request comprises at least a Require header, a Session header, and a Target header.

4. The method of claim 3, wherein the Require header comprises an option-tag that describes an action the client wants the server to perform.

5. The method of claim 4, wherein the action to be performed comprises transferring the RTSP media streaming session to the target.

6. The method of claim 4, wherein the action to be performed comprises sharing the RTSP media streaming session with the target.

7. The method of claim 3, wherein the Session header lists the session to which a request belongs.

8. The method of claim 3, wherein the Target header includes an address of the target device.

9. A client initiated request to modify a Real Time Streaming Protocol streaming media session, comprising:
stream information; and
additional header information used to provide a streaming session to a target device.

10. The request of claim 9, wherein the additional header information comprises at least a Require header, a Session header, and a Target header.

11. The request of claim 10, wherein the Require header comprises an option-tag that describes an action the client wants the server to perform.

12. The request of claim 11, wherein the action to be performed comprises transferring the RTSP media streaming session to the target.

13. The request of claim 11, wherein the action to be performed comprises sharing the RTSP media streaming session with the target.

14. A server initiated setup message for modifying a Real Time Streaming Protocol session, comprising:
transport parameters selected by the server for data transmission; and
additional header information used to provide a streaming session to a target device.

15. The setup message of claim 14, wherein the additional information comprises a Referred By header.

16. A method for providing a Real Time Streaming Protocol (RTSP) media streaming session to a target device, comprising:
receiving a request to modify the RTSP media streaming session from a client;
checking the information in the request for additional header information; and
providing the RTSP media streaming session to the target device using the additional header information.

17. The method of claim 16, wherein the additional header information comprises at least a Require header, a Session header, and a Target header.

18. The method of claim 16, wherein providing the RTSP media streaming session to the target device comprises transferring the RTSP media streaming session to the target device.

19. The method of claim 18, wherein transferring the RTSP media streaming session comprises sending a setup message to the target device.

20. The method of claim 16, wherein providing the RTSP media streaming session to the target device comprises sharing the RTSP media streaming session with the target device.

21. The method of claim 20, wherein transferring the RTSP media streaming session comprises sending a setup message to the target device.

22. A method for providing a Real Time Streaming Protocol (RTSP) media streaming session to a target device, comprising:
receiving a setup message from a server, the setup message comprising, at least a Referred-By header;
joining the RTSP media streaming session.

23. A computer-readable medium having stored thereon a plurality of instructions, the plurality of instructions including instructions which, when executed by a processor, cause the processor to perform the steps of a method for providing a Real Time Streaming Protocol (RTSP) media streaming session to a target device, comprising:
receiving an instruction to provide the RTSP media streaming session to the target device;
generating a request to modify the RTSP media streaming session; and
sending the request to a server.

24. A computer-readable medium having stored thereon a plurality of instructions, the plurality of instructions including instructions which, when executed by a processor, cause the processor to perform the steps of a method for providing a Real Time Streaming Protocol (RTSP) media streaming session to a target device, comprising:
receiving a request to modify the RTSP media streaming session from a client;
checking the information in the request for additional header information; and
providing the RTSP media streaming session to the target device using the additional header information.

25. A computer-readable medium having stored thereon a plurality of instructions, the plurality of instructions including instructions which, when executed by a processor, cause the processor to perform the steps of a method for providing a Real Time Streaming Protocol (RTSP) media streaming session to a target device, comprising:
receiving a setup message from a server, the setup message comprising, the setup message comprising at least a Referred-Byr header;
joining the RTSP media streaming session.
